(19) United States
(12) Patent Application Publication
(10) Pub. No.: US 2008/0256474 A1
(43) Pub. Date: Oct. 16, 2008

(54) Interactive Progress Bar

(76) Inventors: Al Chakra, Apex, NC (US); John F. Sefler, Cary, NC (US); Robert Kainz, Cary, NC (US)

Correspondence Address: HAMILTON & TERRILE, LLP;IBM RSW, P.O. BOX 203518, AUSTIN, TX, 78720, US

(21) Appl. No.: 11/735,569

(22) Filed: Apr. 16, 2007

(51) Int. Cl. G06F 3/048

(52) U.S. Cl. 715/772

(57) ABSTRACT

A method, system and computer-usable medium are disclosed for using an interactive progress indicator bar to graphically display, and interact with, the completion status information of a plurality of computer operations before they are completed. An interactive progress indicator bar is implemented in a graphical user interface (GUI) and comprises a plurality of progress indicator segments. As computer operations are completed, the details of their completion status are entered into a computer operation log and indexed to their corresponding progress indicator segments. Concurrently, color attributes are applied to progress indicator segments to graphically indicate the completion status of their associated computer operations. Predetermined levels of completion status details are displayed through a user gesture as the cursor is placed over a computer operation's corresponding progress indicator segment. A contextual level of completion status information is displayed in a computer operation log that is automatically scrolled to the corresponding completion status information.

### BACKGROUND OF THE INVENTION

1. Field of the Invention

Embodiments of the disclosure relate in general to the field of computers and similar technologies, and in particular to software utilized in this field. Still more particularly, it relates to graphically displaying and interacting with the completion status information of computer operations before they are completed.

2. Description of the Related Art

Conventional computer applications often use a graphical progress indicator to provide users feedback about the completion status of computer operations as they are being performed. Progress indicators are often used during software installations, lengthy calculations, and automated test executions while back-end logs and trace files of the procedures are being written. The typical progress bar provides the user with an estimate of how much time it will take to complete the entire operation and an indication of how much progress has been made thus far.

Prior art approaches have included progress bars, which include a completion progress indicator that comprises a plurality of progress indicator segments. Completed progress indicator segments are generally depicted in a graphical user interface (GUI) as one color and uncompleted progress indicator segments in another. As increments of progress are achieved, the number of completed progress indicator segments increase and the number of uncompleted progress segments decrease. While completion progress indicators may provide some indication of how complete a series of computer operations may be, or an estimate of the time remaining until completion, they typically do not provide completion detail about individual operations. Another approach is to combine a checklist of computer operations with a time remaining progress indicator. The computer operation checklist generally comprises a list of computer operations, each of which has a corresponding graphical icon to symbolize operations that were completed successfully, with errors, or with failures. While the progress indicator with checklist provides a summary of computer operations and their corresponding status through graphical icons, it does not provide meaningful detail about failed operations.

Graphical progress indicators are often used to monitor the progress of time consuming processes such as lengthy sequences of test case executions. In many cases, the results of intermediate operations may be available for review and analysis, even though remaining operations are still pending. Accordingly, users should be able to select a progress indicator segment corresponding to a completed computer operation, review its completion results, and interact with other, associated computer operation information without interrupting the overall process. However, current progress indicator approaches require the user to wait until all operations have been completed to investigate the possible causes of failed operations.

### BRIEF SUMMARY OF THE INVENTION

The present invention includes, but is not limited to, a method, system and computer-usable medium for using an interactive progress indicator bar to graphically display, and interact with, the completion status information of a plurality of computer operations before they are completed. In various embodiments of the invention, an interactive progress indicator bar is implemented in a graphical user interface (GUI) and comprises a plurality of progress indicator segments. As computer operations are completed, the details of their completion status are entered into a computer operation log and indexed to their corresponding progress indicator segments. Concurrently, color attributes are applied to progress indicator segments as they are completed to graphically indicate the completion status of their associated computer operations. For example, a color attribute of green may signify a successfully completed operation, yellow a completed operation with errors, and red a failed operation. As increments of progress are achieved, a completion progress indicator is updated to textually reflect the percentage of completed computer operations.

Details of the completion status of a predetermined computer operation are viewed by selecting a corresponding progress indicator segment through a user gesture. In one embodiment, completion status summary information is displayed through a first user gesture, such as a mouse hover as the cursor is placed over its corresponding progress indicator segment. In another embodiment, a predetermined level of completion status information detail is displayed through a second user gesture, such as a mouse right-click as the cursor is placed over its corresponding progress indicator segment. In yet another embodiment, a contextual level of completion status information is displayed through a third user gesture, such as selecting a menu command displayed as the result of a mouse right-click as the cursor is placed over its corresponding progress indicator segment.

The contextual level of information is displayed in a computer operation log that is automatically scrolled to the corresponding completion status summary, which is followed by completion status detail. The computer operation log can then be scrolled to review the completion status detail of the selected computer operation and its contextual relevance to the completion status of other computer operations. In another embodiment, a screen capture of the computer operation at the time of its completion is similarly indexed to the progress indicator segment and is displayed in context with the computer operation's completion status summary and the completion status detail. The above, as well as additional purposes, features, and advantages of the present invention will become apparent in the following detailed written description.

For example, FIGS. 1a-d, labeled Prior Art, show examples of known progress bar indicators. Referring now to FIG. 1a, a generalized depiction of a completion progress indicator 102 is shown as typically implemented in a graphical user interface (GUI). The completion progress indicator 102 comprises completed progress indicator segments 106 and uncompleted progress indicator segments 108, representing a completion progress 104 of 37%. Completed progress indicator segments 106 are generally depicted in a GUI as one color and uncompleted progress indicator segments 108 in another. As increments of progress are achieved, the number of completed progress indicator segments 106 increase and the number of uncompleted progress segments 108 decrease. It will be appreciated that while completion progress indicators may provide some indication of how complete a series of computer operations may be, they generally do not indicate how long it will take to complete the remaining operations.

Conversely, the indeterminate time progress indicator 110 shown in FIG. 1b provides a simplified visual indication of the time remaining to complete predetermined computer operations (e.g., deleting C:\MyTrash) 112. As computer operations are completed, the slider bar 114 progresses from left to right. By observing the slider bar's 114 rate of progression, a user can achieve a general sense of how much time remains before the operations are completed. In a similar fashion, the position of the slider bar 114 indicates the proportion of completed operations 116 to uncompleted operations 118. Regardless, unlike completion progress indicator 102, indeterminate time progress indicator 110 does not provide a declarative indication of what percentage of the operations have been completed.

The time remaining progress indicator 110 shown in FIG. 1c provides a completion progress summary 122 of the number of completed computer operations as well as an estimate of how long it will take to complete the remaining operations. As operations are completed, they are enumerated within the completion progress summary 122 and a proportionate area 124 of the progress indicator bar changes color (e.g., from white to green, left-to-right) while the uncompleted operations area 126 is reduced accordingly. However, while the completion progress summary 122 may indicate the number of operations completed, it does not indicate the respective number of operations that were completed successfully, with errors, or with failures. Instead, the user is required to wait until all operations have been completed to determine whether or not they were successful.

The progress indicator with checklist 128 shown in FIG. 1d combines a checklist 138 of computer operations with a time remaining progress indicator 132. As computer operations are completed, a proportionate area 134 of the progress indicator bar changes color (e.g., from white to green, left-to-right) while the uncompleted operations area 136 is reduced accordingly. The computer operation checklist 138 comprises a plurality of computer operations, each of which has a corresponding graphical icon 140 symbolizing its individual status. For example, a checkmark may signify a successfully completed operation whereas an ‘X’ may signify a failed or partially successful operation. Similarly, a rotating icon combined with bold text may signify a computer operation that is in progress, while absence of a graphical icon may indicate that the operation has not yet begun. Concurrently, the computer operation indicator 130 provides additional details about the computer operation that is currently in progress and may indicate whether or not the operation was successful. While the progress indicator with checklist 128 provides a summary of computer operations 138 and their corresponding status through graphical icons 140, it does not provide meaningful detail about failed operations. Furthermore, the user has no way to investigate the possible causes of failed operations while the remaining operations are being completed. Instead, they must wait until all operations have completed to determine the cause of failure.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIGS. 1a-d, labeled prior art, show examples of progress bar indicators;

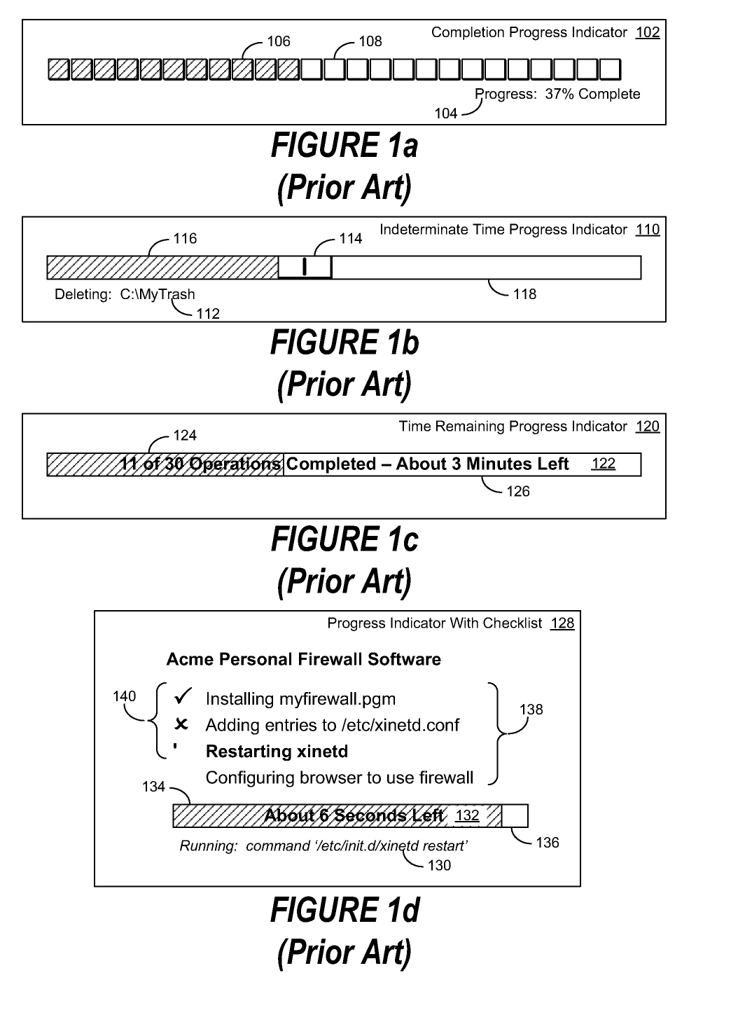

FIG. 2 depicts an exemplary client computer in which the present invention may be implemented;

FIGS. 3a-e show an interactive progress indicator bar;

FIGS. 4a-b show an interactive progress indicator bar as implemented to display computer operation completion information;

FIG. 5 shows an interactive progress indicator bar as implemented with a computer operation log; and

FIG. 6 is a generalized flow chart showing an implementation of an interactive progress bar.

### DETAILED DESCRIPTION

A method, system and computer-usable medium are disclosed for using an interactive progress indicator bar to graphically display, and interact with, the completion status information of a plurality of computer operations before they are completed. In various embodiments of the invention, an interactive progress indicator bar is implemented in a graphical user interface (GUI) and comprises a plurality of progress indicator segments. As computer operations are completed, the details of their completion status are entered into a computer operation log and indexed to their corresponding progress indicator segments. Concurrently, color attributes are applied to progress indicator segments as they are completed to graphically indicate the completion status of their associated computer operations. As increments of progress are achieved, a completion progress indicator is updated to textually reflect the percentage of completed computer operations.

Predetermined levels of detail related to the completion status of a predetermined computer operation are displayed through a user gesture as the cursor is placed over its corresponding progress indicator segment. In one embodiment, a contextual level of completion status information is displayed in a computer operation log that is automatically scrolled to the corresponding completion status information. The computer operation log can then be scrolled to review the completion status detail of the selected computer operation and its contextual relevance to the completion status of other computer operations. In another embodiment, a screen capture of the computer operation at the time of its completion is similarly indexed to the progress indicator segment and is displayed in context with the computer operation's completion status summary and the completion status detail.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

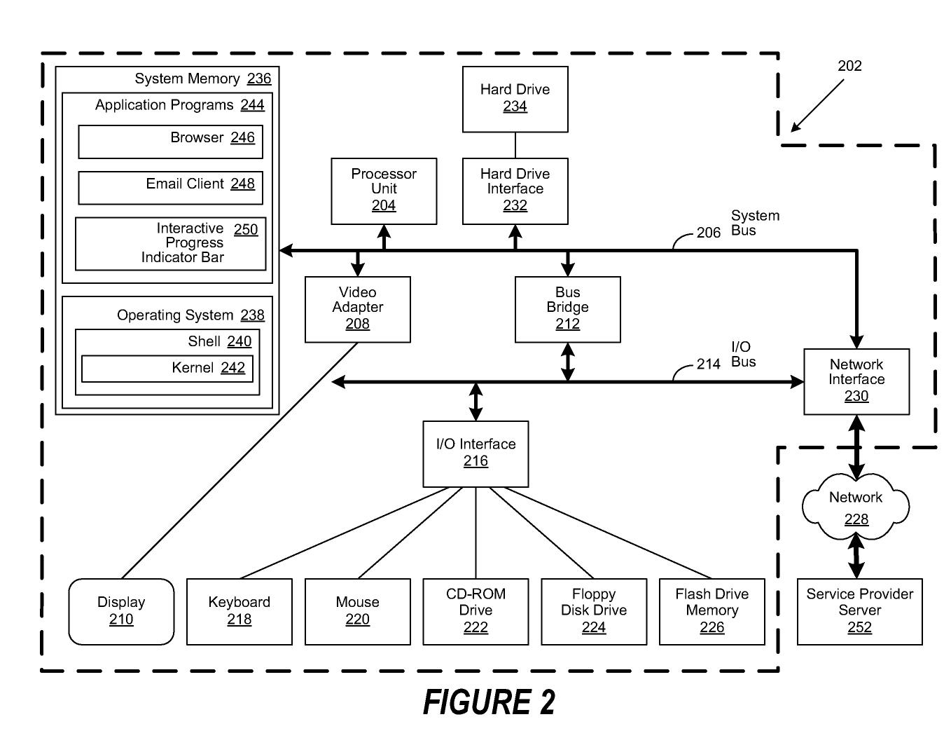

FIG. 2 is a block diagram of an exemplary client computer 202 in which the present invention may be utilized. Client computer 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Client computer 202 is able to communicate with a service provider server 252 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 252.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the client computer's 202 operating system (OS) 238 and application programs 244.

OS 238 includes a shell 240 for providing transparent user access to resources such as application programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and application programs 244, including memory management, process and task management, disk management, and mouse and keyboard management.

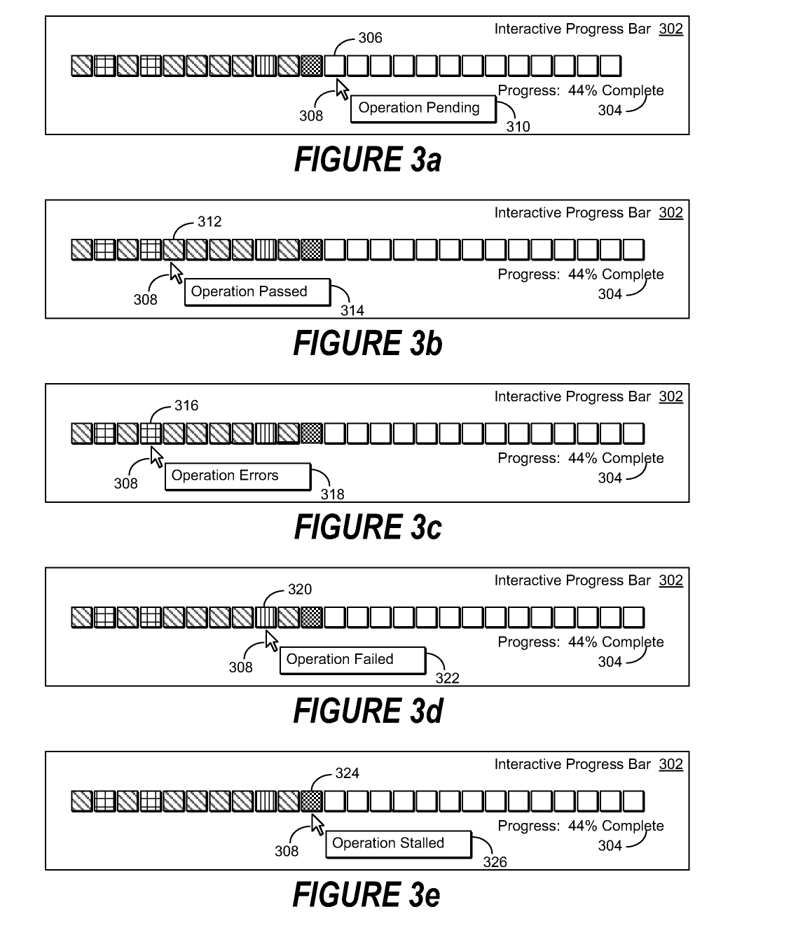

Application programs 244 may include a browser 246 and email client 248. Browser 246 includes program modules and instructions enabling a World Wide Web (WWW) client (i.e., client computer 202) to send and receive network messages to the Internet using HyperText Transfer Protocol (HTTP) messaging, thus enabling communication with service provider server 252. Application programs 244 also an interactive progress bar 250. The interactive progress bar 250 includes code for implementing the processes described in FIGS. 3-6 described hereinbelow. In one embodiment, client computer 202 is able to download the interactive progress bar 250 from a service provider server 252.

The hardware elements depicted in client computer 202 are not intended to be exhaustive, but rather are representative to highlight components used by the present invention. For instance, client computer 202 may include alternate memory storage devices such as magnetic cassettes, Digital Versatile Disks (DVDs), Bernoulli cartridges, and the like. These and other variations are intended to be within the spirit and scope of the present invention.

FIGS. 3a-e show an interactive progress indicator bar 302 as implemented in an embodiment of the invention. In various embodiments, the interactive progress indicator bar 302 comprises a plurality of progress indicator segments. As increments of progress are achieved, completion progress indicator 304 is updated to reflect the percentage of computer operations completed. Concurrently, color attributes are applied to progress indicator segments as they are completed to indicate the completion status of their associated computer operations. In one embodiment, progress indicator segment 306 is depicted in FIG. 3a with a color attribute of white, graphically indicating that its associated computer operation is pending and has not been completed. Supplemental textual status “Operation Pending” 310 is provided through a user gesture such as a mouse hover or right-click as the cursor 308 is placed over corresponding progress indicator segment 306. Similarly, progress indicator segment 312 is depicted in FIG. 3b with a color attribute of green, graphically indicating that its associated computer operation is successfully completed. Supplemental textual status “Operation Passed” 314 is likewise provided through a user gesture as the cursor 308 is placed over corresponding progress indicator segment 312.

In a like manner, progress indicator segment 312 is depicted in FIG. 3c with a color attribute of yellow, graphically indicating errors were incurred during its associated computer operation. As in the preceding cases, supplemental text status “Operation Errors” 318 is provided through the user gestures described herein. Likewise, progress indicator segment 320 is depicted in FIG. 3d with a color attribute of red, graphically indicating a failed computer operation. Placing cursor 308 over progress indicator segment 320 through a user gesture results in supplemental text status “Operation Failed” 322 being displayed. In a similar manner, progress indicator segment 324 is depicted in FIG. 3e with a color attribute of grey, graphically indicating a computer operation that is in a stalled state. Placing the cursor 308 over progress indicator segment 324 with a user gesture results in supplemental textual status “Operation Stalled” 326 being displayed. It will be apparent to those of skill in the art that the application of color attributes to progress indicator segments allows a user to quickly ascertain the completion status of their corresponding computer operation. Further, the completion status of individual computer operations can be textually displayed without waiting for remaining computer operations to be completed.

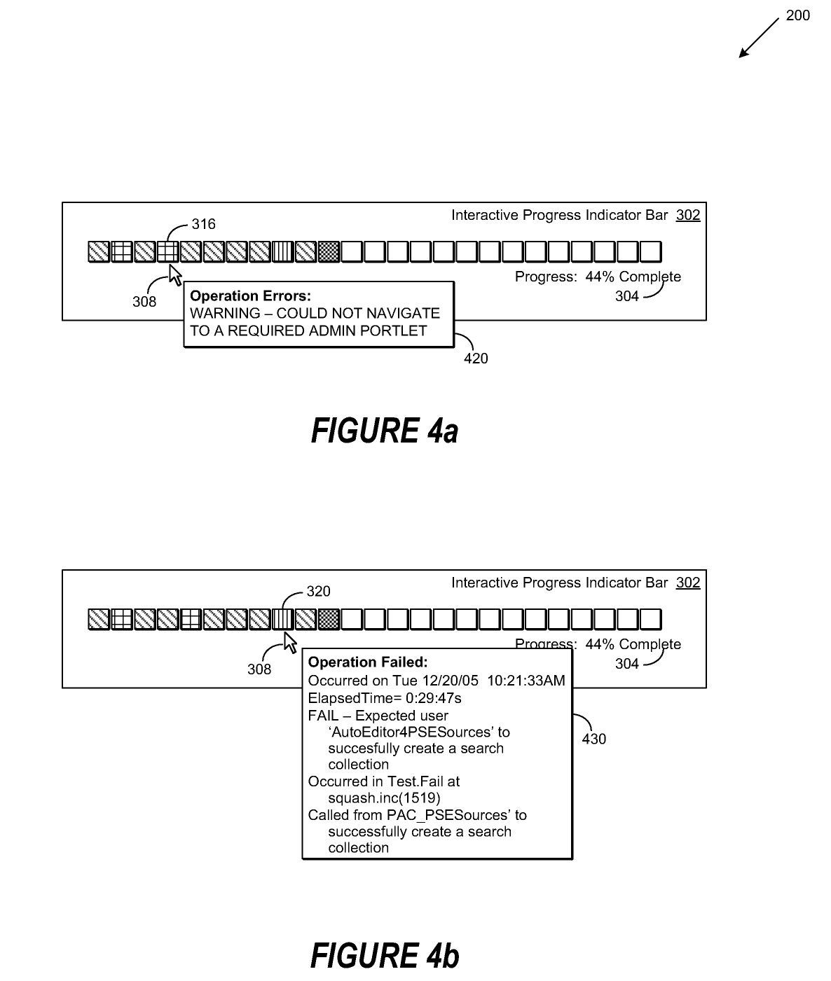

FIGS. 4a-b show an interactive progress indicator bar 302 as implemented in an embodiment of the invention to display computer operation completion information. In various embodiments, the interactive progress indicator bar 302 is implemented in a graphical user interface (GUI) and comprises a plurality of progress indicator segments. As computer operations are completed, the details of their completion status are entered into a computer operation log and indexed to their corresponding progress indicator segments. As increments of progress are achieved, the completion progress indicator 304 is updated to textually reflect the percentage of completed computer operations.

Concurrently, color attributes are applied to progress indicator segments as they are completed to indicate the completion status of their associated computer operations. In one embodiment, progress indicator segment 316 is depicted in FIG. 4a with a color attribute of yellow, graphically indicating that errors were incurred during its associated computer operation. A supplemental textual summary and a first level of error message detail 420 about the completion status of the computer operation is provided through a user gesture such as a mouse hover or right-click as the cursor 308 is placed over its corresponding progress indicator segment 308. As depicted in FIG. 4b, a supplemental textual summary and a second level of error message detail 430 about the completion status of the computer operation is provided through similar user gestures when the cursor 308 is place over progress indicator 308. Skilled practitioners of the art will appreciate that the provision of additional error message detail 420, 430 facilitates determining the cause of errors and failures in completed computer operations while remaining computer operations are pending completion.

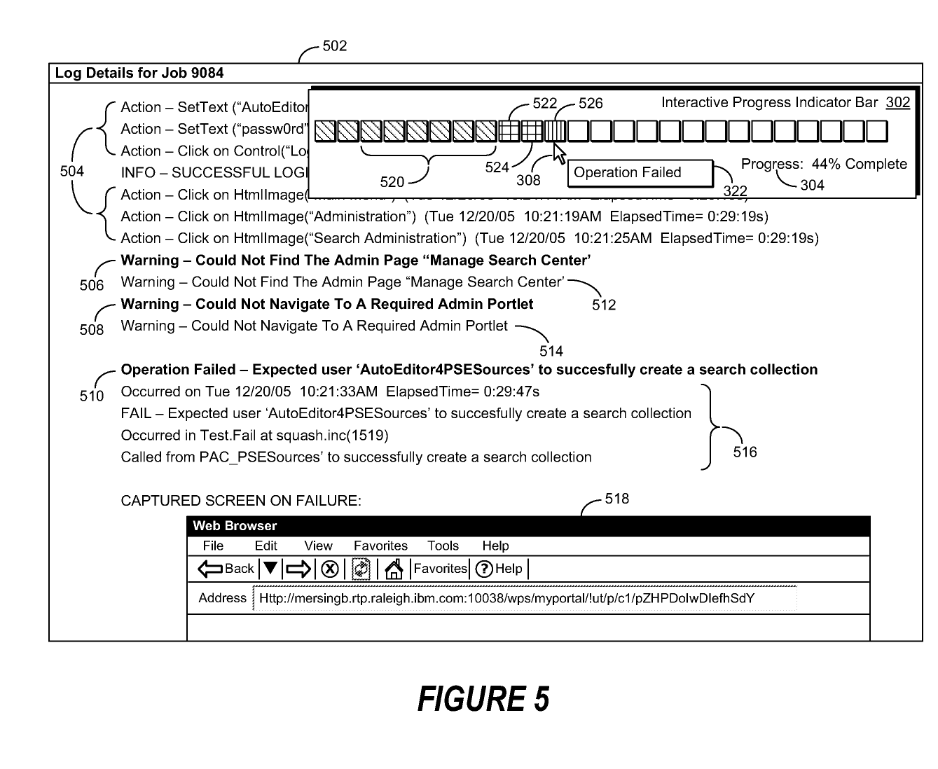

FIG. 5 shows an interactive progress indicator bar 302 as implemented with a computer operation log 502. In various embodiments, the interactive progress indicator bar 302 is implemented in a graphical user interface (GUI) and comprises a plurality of progress indicator segments. As computer operations are completed, the details of their completion status are entered into a computer operation log and indexed to their corresponding progress indicator segments. Concurrently, color attributes are applied to progress indicator segments as they are completed to graphically indicate the completion status of their associated computer operations. For example, a color attribute of green may signify a successfully completed operation, yellow a completed operation with errors, and red a failed operation. As increments of progress are achieved, the completion progress indicator 304 is updated to textually reflect the percentage of completed computer operations.

In one embodiment, progress indicator segments 520, 522, 524, 526 are indexed to their corresponding entries 504, 506, 508, 510 in the computer operation log 502. As depicted in FIG. 5, the completion status summary “Operation Failed” 322 is displayed through a first user gesture such as a mouse hover as the cursor 308 is placed over progress indicator segment 526. A second user gesture, such as a right-click, results in the display of computer operation log 502 automatically scrolled to the corresponding failure message summary 510 followed by failure message detail 516. In another embodiment, a screen capture 518 of the computer operation at the time of its failure is similarly indexed to progress indicator segment 526 and is displayed in context with failure message summary 510 and failure message detail 516. It will be appreciated that determining the cause of failed computer operation 510 is further facilitated by presenting the indexed display of failure message summary 510, failure message detail 516, and screen capture 518 in context with successfully completed operations 504 and error messages of completed operations 512, 514.

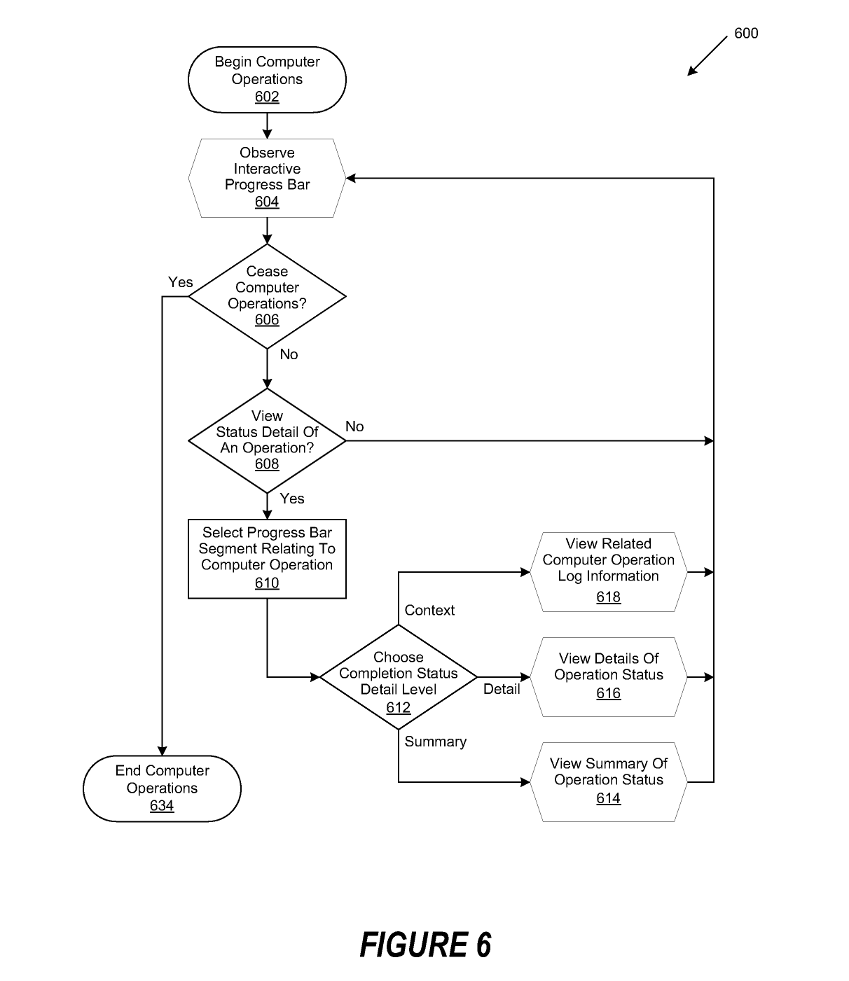

FIG. 6 is a generalized flow chart of an interactive progress bar 600 in accordance with an embodiment of the invention. In various embodiments, an interactive progress indicator bar is implemented in a graphical user interface (GUI) and comprises a plurality of progress indicator segments. As computer operations are completed, the details of their completion status are entered into a computer operation log and indexed to their corresponding progress indicator segments. Concurrently, color attributes are applied to progress indicator segments as they are completed to graphically indicate the completion status of their associated computer operations. For example, a color attribute of green may signify a successfully completed operation, yellow a completed operation with errors, and red a failed operation. As increments of progress are achieved, a completion progress indicator is updated to textually reflect the percentage of completed computer operations.

In this embodiment, computer operations are begun in step 602 and the completion status of the computer operations is monitored by observing the interactive progress bar in step 604. If it is determined in step 606 to cease computer operations, then computer operations are ended in step 634. It is then determined in step 608 if the details of the completion status of a predetermined computer operation are to be viewed. If it is determined to not view completion status details of a predetermined computer operation, then observation of the interactive progress bar continues beginning with step 604.

However, if it is determined in step 608 to view the completion status details of a predetermined computer operation, then a corresponding progress indicator segment is selected in step 610 and a level of completion status detail is chosen in step 612. If a summary level of information is chosen in step 612, then the predetermined computer operation's completion status summary is displayed in step 614 through a first user gesture such as a mouse hover as the cursor is placed over its corresponding progress indicator segment. Once checking of the completion status summary is complete, observation of the interactive progress bar continues, beginning with step 604. If a detail level of information is chosen in step 612, then the predetermined computer operation's completion status detail is displayed in step 616 through a second user gesture such as a mouse right-click as the cursor is placed over its corresponding progress indicator segment. Once checking of the completion status detail is complete, observation of the interactive progress bar continues, beginning with step 604.

If a contextual level of information is chosen in step 612, then a predetermined user gesture, such as selecting a menu command displayed as the result of a mouse right-click, results in the display of computer operation log in step 618. The computer operation log is automatically scrolled to the corresponding completion status summary, which is followed by completion status detail. The computer operation log can then be scrolled to review the completion status detail of the selected computer operation and its contextual relevance to the completion status of other computer operations. In another embodiment, a screen capture of the computer operation at the time of its completion is similarly indexed to the progress indicator segment and is displayed in context with the computer operation's completion status summary and the completion status detail. Once checking of the completion status detail is complete, observation of the interactive progress bar continues, beginning with step 604.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for interacting with a plurality of computer operations within a graphical user interface, comprising:
representing a status of a plurality of computer operations using at least one graphical progress display;
displaying the graphical progress display as a plurality of graphical status elements, the plurality of graphical status elements relating to the plurality of computer operations;
enabling interaction with the graphical status elements of at least one of the plurality of indexed computer operations without affecting operation of the plurality of indexed computer operations.

2. The method of claim 1, wherein the at least one graphical progress display comprises a progress bar.

3. The method of claim 1, wherein the plurality of graphical status elements are configurable to display a color attribute corresponding to the status of a related computer operation.

4. The method of claim 1, wherein the interaction with the status details of the at least one of the plurality of related computer operations is performed before the plurality of computer operations are completed.

5. The method of claim 4, wherein the interaction with the displayed status details of the at least one of the plurality of related computer operations comprises monitoring predetermined computer operations that are not completed.

6. The method of claim 4, wherein the interaction with the displayed status details of the at least one of the plurality of related computer operations comprises reviewing predetermined computer operations that are completed.

7. A system comprising:
a processor;
a data bus coupled to the processor; and
a computer-usable medium embodying computer program code, the computer-usable medium being coupled to the data bus, the computer program code interacting with a plurality of computer operations and comprising instructions executable by the processor and configured for:
representing a status of a plurality of computer operations using at least one graphical progress display;
displaying the graphical progress display as a plurality of graphical status elements, the plurality of graphical status elements relating to the plurality of computer operations;
enabling interaction with the graphical status elements of at least one of the plurality of indexed computer operations without affecting operation of the plurality of indexed computer operations.

8. The system of claim 7, wherein the at least one graphical progress display comprises a progress bar.

9. The system of claim 7, wherein the plurality of graphical status elements are configurable to display a color attribute corresponding to the status of a related computer operation.

10. The system of claim 7, wherein the interaction with the status details of the at least one of the plurality of related computer operations is performed before the plurality of computer operations are completed.

11. The system of claim 10, wherein the interaction with the displayed status details of the at least one of the plurality of related computer operations comprises monitoring predetermined computer operations that are not completed.

12. The system of claim 10, wherein the interaction with the displayed status details of the at least one of the plurality of related computer operations comprises reviewing predetermined computer operations that are completed.

13. A computer-usable medium embodying computer program code, the computer program code comprising computer executable instructions configured for:
representing a status of a plurality of computer operations using at least one graphical progress display;
displaying the graphical progress display as a plurality of graphical status elements, the plurality of graphical status elements relating to the plurality of computer operations;
enabling interaction with the graphical status elements of at least one of the plurality of indexed computer operations without affecting operation of the plurality of indexed computer operations.

14. The computer usable medium of claim 13, wherein the at least one graphical progress display comprises a progress bar.

15. The computer usable medium of claim 13, wherein the plurality of graphical status elements are configurable to display a color attribute corresponding to the status of a related computer operation.

16. The computer usable medium of claim 13, wherein the interaction with the status details of the at least one of the plurality of related computer operations is performed before the plurality of computer operations are completed.

17. The computer usable medium of claim 16, wherein the interaction with the displayed status details of the at least one of the plurality of related computer operations comprises monitoring predetermined computer operations that are not completed.

18. The computer usable medium of claim 16, wherein the interaction with the displayed status details of the at least one of the plurality of related computer operations comprises reviewing predetermined computer operations that are completed.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.

21. A computer-implementable method for interacting with a plurality of computer operations within a graphical user interface, comprising:
representing a status of a plurality of computer operations using at least one graphical progress display;
displaying the graphical progress display as a plurality of graphical status elements, the plurality of graphical status elements relating to the plurality of computer operations; and,
enabling selection of at least one of the plurality of graphical status elements to display status details of at least one of the plurality of indexed computer operations.

22. The method of claim 21, wherein the at least one graphical progress display comprises a progress bar.

23. The method of claim 21, wherein the plurality of graphical status elements are configurable to display a color attribute corresponding to the status of a related computer operation.
